(19) United States
(12) Patent Application Publication
(10) Pub. No.: US 2023/0240187 A1
(43) Pub. Date: Aug. 3, 2023

(54) CONVERSION SYSTEM FOR ZERO TURN LAWN EQUIPMENT

(71) Applicant: Troy Eberly, Hartville, OH (US)

(72) Inventor: Troy Eberly, Hartville, OH (US)

(21) Appl. No.: 18/154,948

(22) Filed: Jan. 16, 2023

Related U.S. Application Data
(60) Provisional application No. 63/304,938, filed on Jan. 31, 2022.

(51) Int. Cl. A01D 69/03; A01D 69/00; A01D 67/00

(52) U.S. Cl. CPC A01D 69/03; A01D 69/002; A01D 67/00; A01D 2101/00

(57) ABSTRACT

A drive wheel and equipment attachment combination for self-propelled hydro-static wheel drive lawn care equipment platforms that converts rear two-wheel drive zero turn equipment with a center mower deck to a four-wheel drive with a universal front implement mount lawncare equipment platform

This application claims the benefit of U.S. Provisional Application No. 63/304,938, filed Jan. 31, 2022.

### BACKGROUND OF THE INVENTION

### 1. Technical Field

This invention related to self-propelled riding or standing lawncare vehicles having independent direct drive rear wheels and centrally positioned under frame mower deck attachments.

### 2. Description of Prior Art

There are no known prior art drive wheel and equipment mounting conversions for existing lawncare direct drive and under frame mower equipment mounts.

### SUMMARY OF THE INVENTION

A conversion assembly and system for modifying an existing self-propelled rear wheel direct drive lawn equipment platform to a four-wheel drive format with a front mounted universal equipment implement support and drive attachment. The conversion replaces existing front caster wheel assemblies and support frame with a pair of independently powered hydrostatic driven front drive wheels with a front mounting implement attachment and drive powered by an existing or auxiliary hydrostatic power supply. A deployable frame stand is provided to support the frame during conversion.

### DESCRIPTION OF THE DRAWINGS

FIG. 1 is a side elevational view of a conventional rear wheel drive lawncare vehicle with front caster wheels.

FIG. 2 is a side elevational view of a converted lawncare vehicle now with four-wheel drive and a front implement (mower deck) mount.

FIG. 3 is a partial enlarged front elevational view of a drive wheel conversion and universal front equipment mount.

FIG. 4 is a partial enlarged top plan view of the converted drive wheel front equipment mount with the mower deck shown in broken lines for positional attachment thereto.

FIG. 5 is an enlarged front elevational view of the conversion drive wheel assembly with an auxiliary frame support shown in solid and broken lines.

FIG. 6 is an enlarged partial side elevational view of a conversion drive wheel assembly with hydrostatic motor and support frame with hydraulic line quick connect fittings.

### DETAILED DESCRIPTION OF THE INVENTION

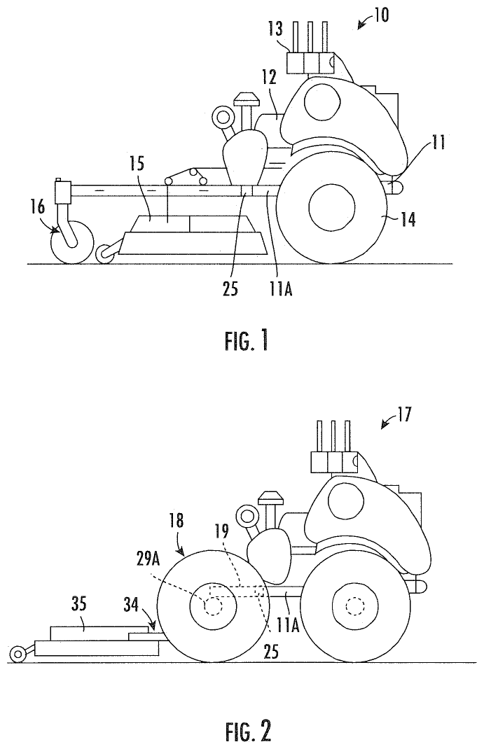

Referring now to FIG. 1 of the drawings, a conventional two-wheel rear drive zero turn lawncare equipment 10 can be seen with a frame 11, an engine 12 and standup user controls 13. A set of power drive rear wheels 14 and an under-frame mower deck 15 having a pair of forward support frame caster wheels 16. The mower deck 15 is removably supported under the frame 11 and powered by a conventional drive pulley and belt assembly, not shown.

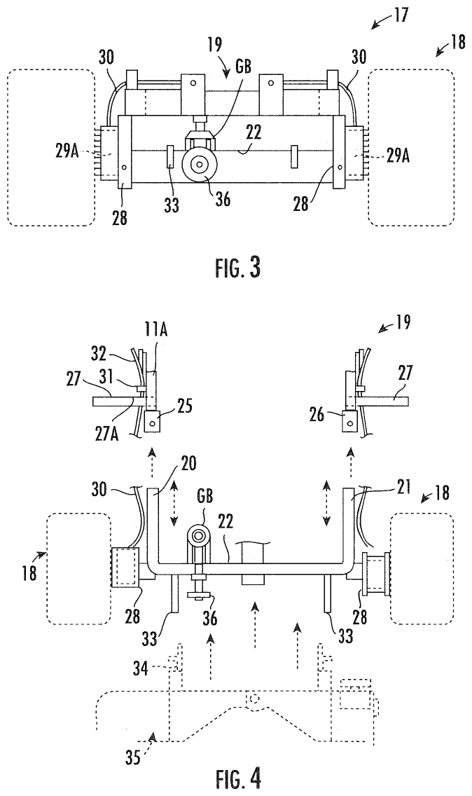

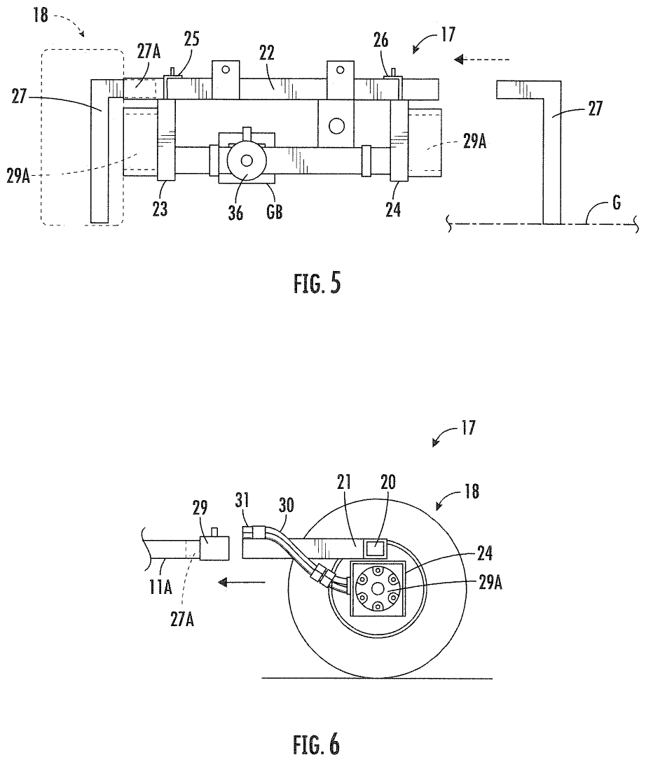

A converted four-wheel drive lawncare equipment 17 of the invention can be seen in FIGS. 2-6 of the drawings wherein a pair of auxiliary hydrostatic driven wheel assemblies 18 are secured to a replacement front frame assembly 19 of the conversion having a pair of spaced parallel main extension frame elements 20 and 21 with a cross support frame element 22 and correspondingly oppositely disposed hydraulic motor wheel mounts 23 and 24 as best seen in FIGS. 3, 4 and 5 of the drawings. The main frame extension elements 20 and 21 are configured for registration into receivers 25 and 26 on a modified existing equipment frame 11A, seen graphically in FIGS. 1, 2 and 4 of the drawings. It will be evident that the specific receiver configurations 25 and 26 may be varied depending on equipment venue and design and therefore are not limited to one so illustrated in the present design.

The modified equipment frame 11A may have auxiliary deployable support legs 27 which, in this example, extend from corresponding fittings 27A on the frame 11A with each being an L-shaped extending outwardly and downwardly leg for ground support engagement as seen in FIGS. 3 and 4 of the drawings in solid and broken lines during conversion with existing frame 11 and removal of caster wheel assemblies 14.

The auxiliary drive wheel assemblies 18 secured to respective wheel frame motor mounts 28 each have wheels 29 and hydraulic motors 29A, best seen in FIGS. 3, 4 and 6 of the drawings. Each of the hydraulic motors 29A have a pair of hydraulic supply lines 30 with quick release line fittings 31 for communication with hydraulic lines 32 of the lawn equipment 10 which provides quick and easy connection during conversion. It will be apparent that independent electric drive motors, not shown, could be substituted for hydraulic drive motors 29A and alternately an electric drive hydraulic pump could be used in this example.

A pair of apertured equipment support brackets 33 extend from the fabricated frame mounts 28 and are configured to registerably engage and support and implement mounting extensions 34 on a, in this example, mower deck 35 shown in broken lines in FIG. 4 of the drawings.

The implement power take off illustrated generally as a drive pulley assembly 36 has a 90-degree gear box GB to convert the drive belt to the required orientation for existing implements known in the industry.

It will be evident from the above description that the so modified conventional two-wheel drive zero turn lawncare equipment 10 can easily and quickly be converted to a superior four-wheel drive vehicle with a more adaptable and usable front implement mount with the hereinbefore described conversion assembly of the invention.

The utilization of auxiliary drive wheels 18 with independent hydrostatic motors 29A provide an improved and adaptable lawncare equipment 17 as best seen in FIG. 2 of the drawings.

As evident from the above description, it will be seen that a substitution of fabrication components under the doctrine of equivalency is available and stating such substitutions are of equal use consideration.

The key element of the hereinbefore described invention is the utilization of the existing zero turn two-wheel drive lawncare equipment 10 with the under-frame mowing implement 15 to a four-wheel front mounted implement supported configuration allowing for broader equipment use and adaptation than before.

It will thus be seen that a new and novel conversion system for zero turn lawn equipment has been illustrated and described and it will be apparent to those skilled in the art that various changes and modifications may be made therein without departing from the spirit of the invention.

Therefore I claim:

1. A four-wheel drive conversion for use with a zero turn two-wheel drive, lawn equipment including,
an equipment frame, an engine, rear drive wheels, front caster wheels and a mower deck,
the front wheel drive conversion comprising, a replacement front frame, a pair of drive wheel assemblies on said replacement frame, extension receivers on said support frame for registerably receiving said replacement front frame in place of the front caster wheels and means for temporarily supporting said equipment for removing said front caster wheels and placing said replacement frame.

2. The four-wheel drive conversion for use with a zero turn two-wheel drive lawn equipment set forth in claim 1 wherein said replacement front frame comprises, a pair of parallel spaced extension frame elements, a cross support frame element in communication therewith and equipment support brackets extending from said cross support frame element.

3. A four-wheel drive conversion for use with a zero turn two-wheel drive lawn equipment set forth in claim 1 wherein said drive wheel assemblies comprises independent hydraulic motors on said respective drive wheels and a source of hydraulic power.

4. The four wheel drive conversion for use with a zero turn two wheel drive lawn equipment set forth in claim 1 wherein said means for temporarily supporting said equipment frame comprises,
a pair of deployable support legs registerable with said equipment frame in spaced relation to said respective extension receivers.

5. The four-wheel drive conversion for use with a zero turn two-wheel drive lawn equipment set forth in claim 2 wherein said cross support frame further comprises,
a power take off drive pulley assembly and gear box thereon.

6. The four-wheel drive conversion for use with a zero turn two-wheel drive lawn equipment set forth in claim 2 wherein said equipment support brackets secure said mower deck to the cross-support frame in spaced relation to the drive wheel assemblies.
